(19) United States
(12) Patent Application Publication
(10) Pub. No.: US 2025/0266892 A1
(43) Pub. Date: Aug. 21, 2025

(54) SYSTEMS, METHODS, AND DEVICES FOR ENHANCEMENT OF LAYER 3 MEASUREMENTS AND PROCEDURES FOR MULTI-RECEIVE USER EQUIPMENT

(71) Applicant: Apple Inc., Cupertino, CA (US)

(72) Inventors: Xiang CHEN, Palo Alto, CA (US); Jie CUI, San Jose, CA (US); Yang TANG, San Jose, CA (US); Dawei ZHANG, Saratoga, CA (US); Haitong SUN, Saratoga, CA (US); Manasa RAGHAVAN, Sunnyvale, CA (US); Qiming LI, Beijing (CN); Konstantinos SARRIGEORGIDIS, Los Gatos, CA (US)

(21) Appl. No.: 19/054,619

(22) Filed: Feb. 14, 2025

Related U.S. Application Data
(60) Provisional application No. 63/554,492, filed on Feb. 16, 2024.

(51) Int. Cl. H04B 7/06; H04W 28/24; H04W 36/08

(52) U.S. Cl. CPC H04B 7/06952; H04W 28/24; H04W 36/08

(57) ABSTRACT

Techniques are provided for a base station (BS) to transmit a beam sweeping configuration of a user device (UE) for layer 3 (L3) measurements and procedures. The BS may be a target cell for a handover, primary secondary cell (PSCell) addition, and/or a PSCell change request directed to the UE. The BS may determine and may transmit a determined beam sweeping configuration based on characteristics of the UE, the BS, and/or additional measurement characteristics. These and many other features and examples are described.

### CROSS-REFERENCE TO RELATED APPLICATIONS

This application claims the benefit of U.S. Provisional Application No. 63/554,492, filed Feb. 16, 2024, the content of which is herein incorporated herein by reference in its entirety for all purposes.

### FIELD

This disclosure relates to wireless communication networks and devices.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling network nodes and access points to communicate with one another in a variety of ways. In some scenarios, UEs may communicate with multiple base stations concurrently.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an example process for determining a beam sweeping configuration according to one or more implementations described herein.

FIG. 2 is a diagram of an example network according to one or more implementations described herein.

FIG. 3 is a diagram of an example process for configuring a Rx beam sweep of a UE according to one or more implementations described herein.

FIG. 4 is a diagram of an example of user equipment performing receive beam sweeping according to one or more implementations described herein.

FIG. 5 is a diagram of an example process for determining a beam sweeping factor according to one or more implementations described herein.

FIG. 6 is a diagram of examples for configuring default and fast beam sweeping according to one or more implementations described herein.

FIG. 7 is a diagram of a process for configuring a Rx beam sweep of a UE according to one or more implementations described herein.

FIG. 8 is a diagram of a process for configuring a Rx beam sweep of a UE according to one or more implementations described herein.

FIG. 9 is a diagram of an example of components of a device according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE may refer to a smartphone, tablet computer, wearable wireless device, a vehicle capable of wireless communications, and/or another type of a broad range of wireless-capable device.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include improving power consumption and reducing the time required to assess prospective handovers and multi-cell connections.

Some aspects of telecommunications may be organized and implemented according to different layers of functionality and communication, such as layer 1 (L1), layer 2 (L2), and layer 3 (L3). L1 may include the physical channels, procedures, measurements, modulation schemes, and the like, associated with generating, transmitting, and receiving electromagnetic signals at a UE or at a base station. L2 may include addressing and/or error correction procedures and may include a medium access control (MAC) and radio link control (RLC) sublayer to interface with L1 and correct for potential errors in data transmission from the UE to the base station, or vice-versa. L3 may include the logical addressing and routing required to communicate data from the base station to the UE, and may include a radio resource control (RRC) sublayer. The RRC sublayer may include the procedures and/or measurements required to establish connections between the UE and the base station, to page the UE, and/or notify the base station about current measurement conditions (e.g., indicating quality of service (QoS) and/or indicating measurement mobility) indicated by the UE.

Generally, L3 functionality may include a UE measuring signals transmitted between the UE and the network and reporting the measurements to the network and/or the performance of one or more procedures. Examples of such procedures may include handover procedures, adding or reassigning of a primary cell (PCell) of a secondary cell group (SCG) (PSCell) for carrier aggregation (CA) or dual connectivity (DC), and more.

A PSCell may include a primary cell of a group of secondary cells that are able to serve the UE, including the prospective PSCell and/or one or more other cells, and may be responsible for initiating access with the UE (e.g., for dual connectivity, described further herein). Adding a PSCell may include a scenario in which a secondary cell is newly selected to serve the UE. The UE may obtain a RRC connection reconfiguration request from a master node (MN), and thereafter may perform a random access procedure with a secondary node (SN) to initiate data communication, corresponding to the selected PSCell. Changing a PSCell may include a scenario in which the UE changes from exchanging data with an initial PSCell (e.g., a source SN (S-SN)) to exchanging data with an updated PSCell (e.g., a target SN (T-SN)). The MN or S-SN may indicate to the other node that a release of the S-SN is required, and confirmation of that release may be confirmed by the other node. The UE may receive a RRC connection reconfiguration request from the MN and may configure circuitry to support communication with the T-SN (e.g., corresponding to updated PSCell) to the MN. The T-SN may receive an indication from the MN that reconfiguration is complete and may perform a random access procedure with the UE to initiate data transfer.

CA may involve aggregating a plurality of components carriers (CCs) to improve a speed of data communication by assigning a plurality of frequency channels and/or sub-channels (e.g., from a single base station) for communication with the UE. DC may involve concurrent data links established between the UE, a first node, and a second node. The first node, for example, may be a millimeter-wave (mmWave) node associated with a primary cell, and the second node may be a mmWave or an LTE node associated with a secondary cell. Benefits of CA may include an improvement of data throughput due to effective widening of the frequency channel allocated for data transmitted from a base station to a UE. Benefits of DC may similarly improve data throughput as described with reference to CA and may additionally serve scenarios in which a backhaul link between the base station and the UE is non-ideal.

Aspects of telecommunications may also, or alternatively, be organized and implemented according to different frequency bands, such as frequency band 1 (FR1) and frequency band 2 (FR2). FR1 may include frequencies spanning from 410 megahertz (MHz) to 7125 MHz, FR2 may include frequencies spanning from 24250 MHz to 71000 MHz. FR2 may include FR2-1 and FR2-2. FR2-1 may include 24250 MHz-52600 MHz, and FR2-2 may include 52600 MHz-71000 MHz.

Managing and operating a telecommunications network may include radio resource management (RRM). RRM may involve the techniques and procedures facilitating the scheduling, cell search, cell reselection, cell handover, location services, establishment of connection, re-establishment of connection, power control, and the like that a base station and/or a network including the base station uses to manage a communication link with a UE. In some scenarios, RRM may involve enabling a UE to receive DL communications via single-reception (Rx) reception and/or multi-Rx reception (sometimes referred to as multi-Rx chain reception).

Single-Rx reception may include scenarios in which a single beam is transmitted from a base station to the UE at a given instant in time, such as a series of time-delimited synchronization signal bursts (SSBs) formed by one or more massive multiple input multiple output (MIMO) antenna panels included at the base station. In such scenarios, the UE may configure one or more antenna panels to serially receive and detect the series of SSBs. Multi-Rx reception may include scenarios in which a plurality of beams are transmitted from a plurality of base stations to the UE. In such scenarios, the UE may configure its antenna panel(s) to concurrently receive the plurality of beams from the plurality of base stations.

Benefits of single-Rx reception may include saving power (e.g., battery power), a diminished risk of overheating, and more. By contrast, benefits of multi-Rx reception relative to single-Rx reception may include reducing an amount of time required to detect beams transmitted by one or more base stations, and may therefore reduce a time delay introduced during handover, PSCell addition, and PSCell modification. An ability of a UE to perform L3 measurements and procedures in a multi-Rx state may differ from the ability to do so in a single-Rx state due to beam management capabilities, configurations, and/or operating conditions of the transmitter and/or receiver at the base station and/or UE. However, despite the potential benefits of prompting or enabling UEs to transition between single-Rx reception and multi-Rx reception, currently available telecommunication technologies fail to provide any, or adequate, solutions for doing so. Indeed, currently available technologies fail to provide solutions that enable a network to utilize the multi-Rx capabilities of a UE for L3 measurements and procedures.

One of the above-described problems includes defining measurements and procedures to reduce interruption time introduced by cell handover, cell selection, and/or cell reselection. As an example, a first base station corresponding to a first cell may initiate handover to a second base station corresponding to a second cell (e.g., a target cell), both of which may operate in the FR2 frequency range, while concurrently maintaining UE connectivity with a base station operating in the LTE or FR1 frequency range. The procedures herein may reduce the amount of time required by at least cell search procedures and/or cell evaluation procedures. For example, a base station may specify a fast beam sweeping configuration to the UE, which may concurrently sweep through a plurality of beam configurations corresponding to an antenna configuration at the UE, reducing the cell search time.

In some scenarios, an interruption time is introduced during cell selection, such as a handover interruption time associated with a handover procedure. For example, the interruption time may include the time between an end of a last transmission time interval (TTI) that includes a RRC command on a physical downlink shared channel (PDSCH) of the initial cell, and the time the UE starts transmission of the new PRACH, excluding delay required by RRC-related procedures. In particular, the interruption time may include a time required to search for the target cell (T_{Search}). As an example, T_{Search} may have a value that corresponds to a multiple of two or more factors: (1) a SSB based measurement timing configuration (SMTC) periodicity, which may refer to an amount of time between the initiation of successive SSB bursts transmitted target cell to evaluate cell quality, and (2) a beam sweeping factor, which may include a Rx beam sweeping factor (N). The beam sweeping factor N may be a default value, or may be determined by the initial and/or target cell. This interruption time may therefore be a first value based upon a default beam sweeping factor, and in some scenarios may be reduced as determined by the initial and/or target cell by defining a bean sweeping factor N that is less than the default value.

Thus, the measurements and procedures described herein may define the procedures, measurements, and configurations of UE provided by base stations. The examples described herein include a base station capable of transmitting a beam sweeping factor that is a hard-coded, default value, or a “fast” beam sweeping factor to reduce the interruption time described above. Additionally, the examples described herein include the layer 3 (L3) signaling and/or mechanisms that the UE can use to indicate single-Rx and/or multi-Rx operation to the base station. In some scenarios, the UE power consumption can be reduced when the UE is configured based upon a multi-Rx connection with a plurality of base station, such as a fast beam sweeping configuration for FR2-only single carrier, FR2-only CA, and/or default beam sweeping for a FR1-FR2 CA/DC or EN-DC configuration. It is understood description of scenarios herein in which a beam sweeping configuration is determined based upon CA and/or DC operations optionally applies to FR2-only single carrier configurations, such as using a fast beam sweeping configuration. In some scenarios, the base station can indicate the beam sweeping configuration when CA is configured, when a PSCell is added, when a PSCell is changed, and/or during CA/DC operating via dedicated RRC/MAC CE/DCI signaling. These and many other features and examples are described below with reference to the Figures.

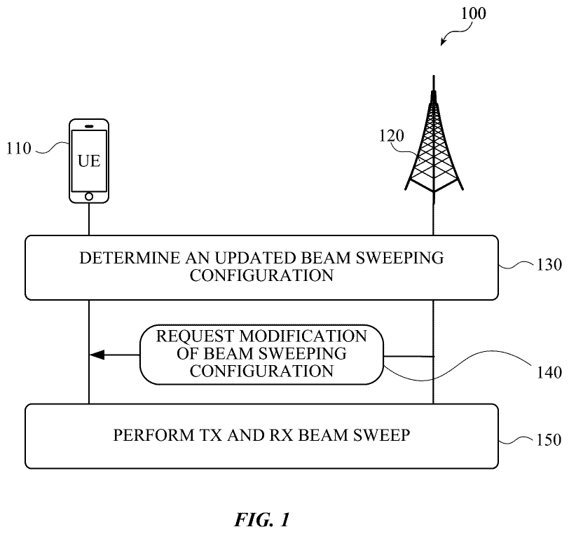

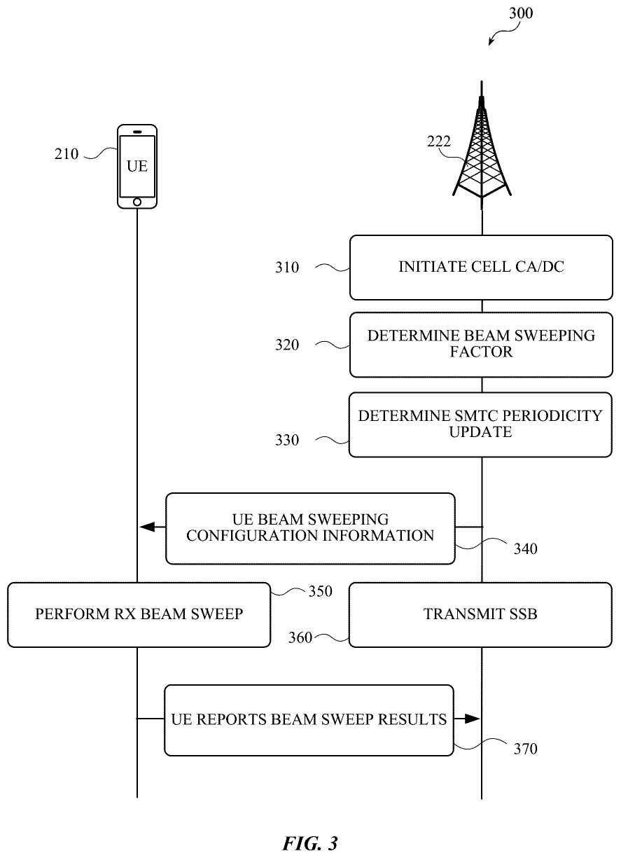

FIG. 1 is a diagram of an example of an example process 100 for determining a beam sweeping configuration according to one or more implementations described herein. Process 100 may be implemented by UE 110 and base station 120. While not shown, UE 110 may receive an indication and/or information including a configuration from base station 120. For example, the base station 120 may transmit an indication that UE 110 is to be configured for FR2-CA operation (described further herein), that the UE 110 is to be configured for FR1-FR2 CA or DC operation, that UE mobility measurements indicate that multi-Rx or single-Rx may be preferable, that UE 110 is in a location conducive to multi-Rx or single-Rx operations, that UE 110 reports that a quality of service (QoS) may be sufficient to support multi-Rx operation, and/or some combination thereof. Additional information and/or indications are described with reference to FIG. 3.

In some scenarios, base station 120 may determine that UE 110 is to perform a Rx beam sweep based upon an updated beam sweeping configuration (block 130). In some scenarios, the updated beam sweeping configuration is based upon a beam sweeping factor, which may be within a range of values up to a maximum value. As an example, the beam sweeping factor N may be a whole number, from 1 to 8 for FR2-1 operations, and from 1 to 12 for FR2-2 operations. In some scenarios, the selected beam sweeping factor is based upon an antenna implementation of the UE 110. For example, the UE may include two antenna panels, each supporting up to two L3 beams, and the beam sweeping factor may be set to two.

In some scenarios, when UE 110 has indicated (e.g., via capability information described further herein) that the UE prefers to support single-Rx operation, the base station 120 may ignore any determined fast beam sweeping factor (described further herein) and my request UE 110 be configured based upon a default beam sweeping factor (e.g., 8 for FR2-1 or 12 for FR2-2). In some scenarios, when UE 110 has indicated capability of supporting multi-Rx operation, base station 120 may request UE 110 be configured based upon the fast beam sweeping factor (e.g., N=2, as described in the above example). In some scenarios, base station 120 determines that UE 110 is to support single-Rx or multi-Rx operation, without obtaining an indication of preference from UE 110.

In some scenarios, base station 120 may transmit a request to modify a beam sweeping configuration of UE 110 (block 140). For example, the modified beam sweeping configuration may include a beam sweeping factor determined during block 130. In some scenarios, in response to receiving the request modification, UE 110 configures one or more antenna panels included in UE 110 and/or analog and/or RF circuitry to perform a Rx beam sweep in accordance with the modified beam sweeping configuration. In some scenarios, the Rx beam sweep is used for L3 measurements and quality reporting to the base station 120. For example, the L3 measurements may include intra-frequency NR measurements, inter-frequency NR measurements, and/or inter-RAT measurements for E-UTRA of UE 110, which may include reference signal received power (RSRP), reference signal received quality (RSRQ), and/or signal to interference noise ratio (SINR) obtained by UE 110 and transmitted to the base station 120. It is understood that the beam sweeping configuration(s) in some scenarios apply to L3 measurements in general, and in some scenarios apply to L3 procedures (and not to additional or all L3 measurements, other than those related to L3 procedures).

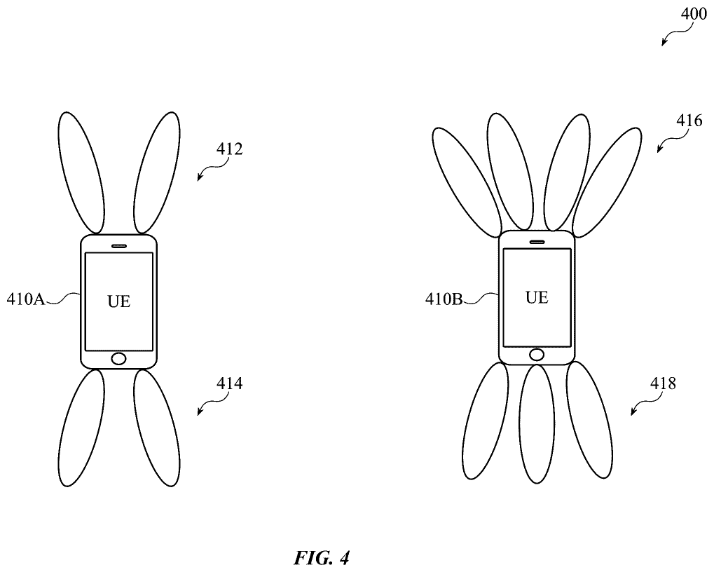

In some scenarios, UE 110 may perform an Rx beam sweep in accordance with the modified beam sweeping configuration (block 150). For example, base station 110 may perform a transmit (Tx) beam sweep, transmitting one or more SSB bursts cycling through different beam configurations of one or more antenna panels coupled to the base station 120. The UE 110 may cycle through a plurality of beam configurations by modifying the weighting and/or delay of signals received by one or more antenna panels included in the UE 110. The Rx beam sweep may include concurrently forming two or more beams to measure transmissions obtained from base station 120 and/or additional or alternative base stations. Additional details regarding beam sweeping configurations are described with reference to FIGS. 4-6.

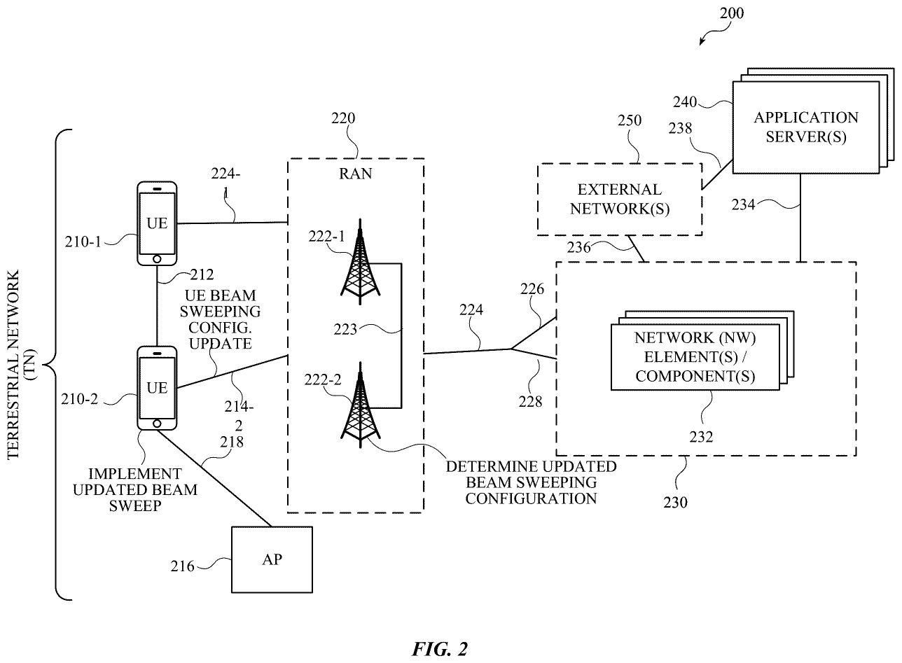

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210-1 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

In some implementations, UE 210 and base station 222 may communicate information to establish beam sweeping configurations of the UE via channel 214-2. For example, as described above, the base station 222-1 may correspond to an initial cell that UE 210-2 is communicatively coupled with, and base station 222-2 may correspond to a target cell that the UE 210-2 begins to communicate with (e.g., in response to a handover request, a designation by the base station 222-1 that base station 222-2 is to be added or changed to be the PSCell for multi-Rx communication). In some scenarios, base station 222-2 may determine that a beam sweeping configuration for the UE 210-2. The determination may include a Rx beam sweeping factor N of the UE 210-2, a SMTC periodicity of the base station 222-2, a pattern of SMTC bursts, whether the UE 210-2 should operate in a single-Rx or multi-Rx configuration (e.g., beam sweeping configuration), and/or some combination thereof.

In some scenarios, the UE 210-2 and/or base station 222-2 exchange information to establish the Rx beam sweeping configuration of the UE 210-2 via one or more signaling mechanisms. For example, the UE 210-2 may indicate that multi-Rx operation should be activated or deactivated based upon UE assistance information (UAI) mechanisms. UAI may include a RRC message transmitted from the UE 210-2 to the base station 222-2 (or base station 222-1) in response to receiving a RRC reconfiguration request and may include information descriptive of the capability UE 210-2. In particular, the UE 210-1 may transmit overheating assistance information and/or a max MIMO configuration to indicate that it presently is able to support single-Rx or multi-Rx downlink. As an example, the overheating assistance information may temporarily reduce the number of maximum secondary component carriers for enhanced-DC downlink. Base station 222-2, for example, may determine that the overheating assistance information corresponds to a request to restrict the UE downlink to single-Rx, rather than multi-Rx, and may reduce the number of MIMO layers of each serving cell of a secondary cell group (e.g., receiving a single stream corresponding to a single MIMO layer, instead of receiving a plurality of streams concurrently corresponding to a plurality of MIMO layers). Additional procedures and measurements are described with reference to FIGS. 1 and 3.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The AP 216 may comprise a local wireless connection, such as a connection consistent with any IEEE 702.11 protocol, and AP 216 may comprise a wireless fidelity (Wi-Fi®) router or other AP. While not explicitly depicted in FIG. 1, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink (UL) and downlink (DL) dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed band or spectrum may include the 5 GHz band. In an additional or alternative example, an unlicensed spectrum may include the 5 GHz unlicensed band, a 6 GHz band, a 60 GHz millimeter wave band, and more.

A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210-2 within a cell) may be performed at any of the RAN nodes 222 based on channel quality information fed back from any of UEs 210. The downlink resource assignment information may be sent on the PDCCH used for (e.g., assigned to) each of UEs 210.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 222 may be configured to communicate with one another via interface 223. In implementations where the system is an LTE system, interface 223 may be an X2 interface. In NR systems, interface 223 may be an Xn interface. In some implementations, such as a standalone (SA) implementation, interface 223 may be an Xn interface. In some implementations, such as non-standalone (NSA) implementations, interface 223 may represent an X2 interface and an XN interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

FIG. 3 is a diagram of an example process 300 for configuring a Rx beam sweep of a UE. Process 300 may be performed by UE 210 and/or base station 222 described with reference to process 300 may be implemented by UE 210 and/or base station 222, respectively. In some implementations, some or all of process 300 may be performed by, or in combination with, one or more other systems or devices, including one or more of the devices of FIG. 2.

Additionally, process 300 may include one or more fewer, additional, differently ordered and/or arranged operations than those shown in FIG. 3, including other processes and/or operations discussed herein. For example, process 300 may include operations preceding, performed in parallel with, and/or following one or more of the depicted operations. Furthermore, some or all the operations of process 300 may be performed independently, successively, simultaneously, etc., of one or more of the other operations of process 300. As such, the techniques described herein are not limited to a number, sequence, arrangement, timing, etc., of the operations or processes depicted in FIG. 3.

In some scenarios, a base station is to initiate CA/DC configuration (block 310) for the UE. For example, while not shown, base station 222 may serve the UE 210 using multiple carrier frequencies (e.g., in CA operation) or may serve as a PSCell that is being added as a PSCell to support DC with the UE 222. In some scenarios, the base station 222 (or another base station in communication with base station 222) may indicate that due to network congestion, load balancing requirements, mobility measurements and/or metrics previously received from the UE 210, and/or additional or alternative factors that the UE 210 is to initiate multi-Rx operation or single-Rx operation. Accordingly, base station 222 or the other base station may determine and/or indicate to the UE 210 that CA operation is to initiate, that the base station 222 is to be newly added to support DC operation, and/or that base station 222 is to replace another PSCell to support DC operation. Additionally or alternatively, the base station 222 may determine that the UE 210 has reported that the UE mobility indicates that received signal quality, power and/or signal to noise ratio may be sufficient to support CA or DC operation, and accordingly may determine the UE 210 may be capable of supporting multi-Rx operation. In some scenarios, the base station 222 may indicate that FR2-only single carrier operation is to be supported, and may perform one or more operations to cause the UE 210 to perform beam sweeping (e.g., fast beam sweeping) similar to as described with reference to CA/DC beam sweeping herein.

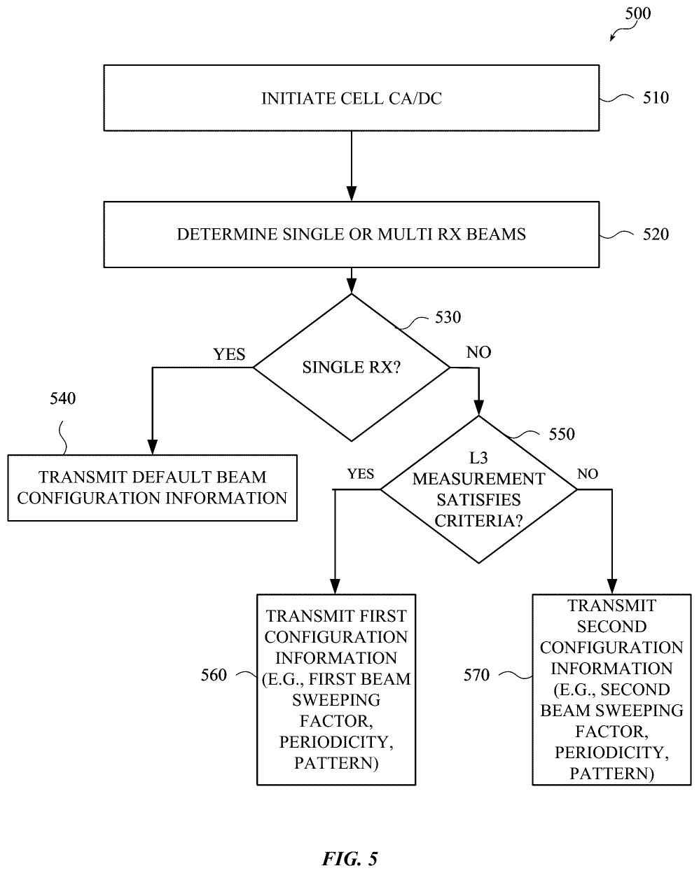

In some scenarios, base station 222 may determine a beam sweeping factor for the UE 210 (block 320). For example, the base station 222 may determine that the UE 210 is to use a fast beam sweeping factor as described further herein or is to use a default beam sweeping factor. As described with reference to FIG. 1, FIG. 4, and FIG. 5, the beam sweeping factor may be up to a predefined or default value (8 for FR2-1 single carrier and/or CA/DC, and 12 for FR2-2 single carrier and/or CA/DC). In some scenarios, base station 222 may ignore any determinations and/or requests to modify the beam sweeping factor to be a fast beam sweeping factor that is less than the predefined value. For example, base station 222 may determine that the UE 210 is to perform a Rx beam sweep using a default beam sweeping factor when the UE 210 is to operate in a single-Rx configuration. In some scenarios, when the base station 222 determines that the UE 210 may support multi-Rx operation, the beam sweeping factor may be determined to be a fast beam sweeping factor. For example, the beam sweeping factor may be less than the predefined value, based upon an implementation of antenna panel(s) at the UE 210. The antenna implementation may include a number of antenna panel(s) and/or groupings at the UE 210, as described with reference to FIG. 4.

In some scenarios, the UE 210 indicates a preference or capability for supporting multi-Rx operation via one or more signals, which the base station 222 may use to determine the beam sweeping factor. For example, the UE 210 may transmit uplink control information (UCI) over a physical uplink control channel (PUCCH), providing base station 222 with an indication that multi-Rx operation may be preferred and/or supported by the UE 210. Accordingly, base station 222 may determine the beam sweeping factor for UE 210 is to be a fast beam sweeping factor. Thus, UE 210 may use lower level signal to indicate beam sweeping capability. In some scenarios, the UE 210 may use control command exchanges between the UE 210 and the base station 222 to indicate a preference or capability for supporting multi-Rx operations. For example, the UE 210 may transmit an indication of the preference or capability via the medium access control (MAC) control element (MAC CE). Accordingly, UE 210 may vary the timing and/or flexibility with which UE 210 may notify base station 222 that multi-Rx operation is supported and/or desired.

In some scenarios, the beam sweeping factor may be determined in accordance with information obtained from the UE 210. For example, as described above, the UE 210 may transmit UAI overheating information, and/or a preference for a maximum number of MIMO layers for L3 measurements and/or procedures. As an example, UE 210 may indicate that UE operating temperature and/or may indicate that the UE 210 may overheat attempting to support CA/DC operation due to the additional power received at the UE 210 by the additional carriers provided by base station 222. Similarly, UE 210 may indicate that a maximum number of MIMO layers may be restricted (at least temporarily) to save power consumption of the UE 210 (e.g., for battery saving and/or to prevent overheating). In some scenarios, as described above, the Rx beam sweeping configuration may depend upon a configuration of one or more antennas and/or antenna panels included at the UE 210.

FIG. 4, for example, illustrates example UEs 400 configured for different multi-Rx beam sweeping configurations. For example, UE 410A may include two antenna panels, each configured to perform a beam sweep while the other antenna panel performs a beam sweep. Beams 412, for example, may be formed by the first antenna panel, and beams 414 may be formed by the second antenna panel. The fast beam sweeping factor may be based upon the maximum number of beams formed by the panels included at 410A (e.g., two beams). For example, the base station 222 at block 320 may implement a fast beam sweeping factor based upon the knowledge that the UE 210 is capable of supporting two Rx beams via two antenna panels concurrently, cycling through two possible Rx beam configurations for each panel. Accordingly, the Rx beam sweeping factor may be two (2) in the case of UE 410A. UE 410B may include two panels, a first panel configured to form beams 416 including four beam configurations and a second panel configured to form beams 418 including three beam configurations. In such an example, the beam sweeping factor may be the maximum number of beams formed by the panels of UE 410B (e.g., four beams), and base station 222 may determine that a fast beam sweeping factor is to be set to four.

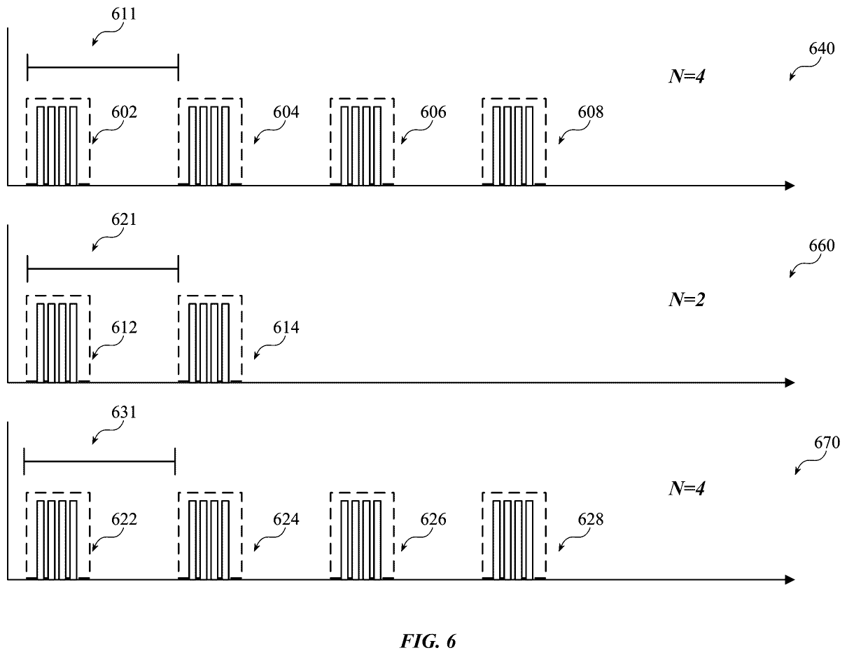

Turning back to FIG. 3, and as described with reference to FIG. 5 and FIG. 6, base station 222 may determine a modification of SMTC periodicity and/or pattern (block 330). The modification may include a change in the periodicity of the SMTC based upon the determined beam sweeping factor, and/or may include forgoing transmitting of one or more SSB bursts. Thus, base station 222 may determine a timing and/or pattern of the Rx beam sweeping configuration performed by UE 210, and/or a timing and/or pattern of transmit (Tx) beam sweeping performed by base station 222.

In some scenarios, base station 222 transmits information associated with the determined beam sweeping configuration to UE 210 (block 340). As described above, the information may designate the beam sweeping factor, the SMTC pattern, and/or the SMTC periodicity. UE 210 may receive that information, and prepare to perform one or more Rx beam sweeps based upon the received information.

In some scenarios, the base station 222 and UE 210 may perform one or more procedures based upon the indicated beam sweeping configuration. For example, UE 210 may scan for SSB beams periodically transmitted by the base station 222 (e.g., blocks 350 and 360, respectively). The UE 210 may receive the SSB beams, and may extract a primary synchronization signal, a secondary synchronization signal, and a physical broadcast channel (PBCH), and/or demodulation reference signal (DMRS). The UE 210 may also measure the received signal power (e.g., of a SSB signal when transitioning from idle mode, or from channel state information reference signals (CSI-RS) in connected mode). The UE 210 may determine the highest signal power, quality, and/or signal to noise ratio and report a beam that is well suited—or more optimal relative to alternative beams—for further communication to the base station 222 (block 370). For example, the UE 210 may use a physical random access channel (PRACH) and transmit a preamble corresponding to the chosen beam, and the base station 222 may receive and continue to perform one or more attachment and/or data communication related procedures.

In some scenarios, the UE beam sweeping configuration information may be communicated via signaling from the base station 222 to the UE 210. For example, the information may be included in a radio resource control (RRC) signaling dedicated for indicating the beam sweeping configuration to the UE 210. The RRC may refer to a sublayer of L3 responsible for controlling connection, setup, mobility measurement and/or management, and security of communication between the UE 210 and the base station 222. In some scenarios, when configuring base station 222 to support CA operation with the UE 210, base station 222 may transmit a RRC connection reconfiguration request to the UE 210, which may transmit an acknowledgement of the request, reconfigure circuitry included in the UE 210 to support CA (e.g., to perform fast beam sweeping or default beam sweeping), and may transmit back an indication that reconfiguration is complete. In some scenarios, the information indicating the modified beam sweeping configuration may be transmitted while configuring the UE 210 for CA, when the base station 222 may newly assume the role of the PSCell for the UE 210 (e.g., when newly establishing DC, and/or when replacing another PSCell for DC). In some scenarios, the base station 222 may transmit an indication to modify the beam sweeping configuration to UE 210 while the UE 210 is already configured in a first CA or DC configuration. In some scenarios, the base station 222 may perform one or more procedures to determine beam sweeping configurations, including a beam sweeping factor, a SMTC periodicity, and/or a SMTC pattern.

FIG. 5 is a diagram of an example process 500 for determining a beam sweeping configuration according to one or more implementations described herein. In FIG. 5, a base station may initiate a CA/DC configuration (block 510). In some scenarios, the CA/DC configuration may include one or more characteristics of the procedures described with reference to block 310.

In some scenarios, a base station such as base station 222 may determine whether a UE is to be configured for single-Rx or multi-Rx operation (block 520). The determination may include that the UE indicated via UAI that single-Rx operation is preferred (e.g., overheating UAI, and/or a preferred maximum number of MIMO layers). Additionally or alternatively, the determination may be based upon previous receipt of information from the UE indicating mobility estimates, location of the UE, and/or a quality of service (QoS) requirement as determined by the UE (e.g., to minimize handover-related interruption). In some scenarios, the base station uses such information to determine whether single-Rx or multi-Rx operation is to be indicated to the UE.

In some scenarios, the base station instructs the UE to configure a beam sweep in single-Rx mode (block 530—YES). Accordingly, the UE may perform a beam sweep using a default beam sweeping factor and/or using a default beam sweeping configuration (e.g., N=8 for FR2-1, N=12 for FR2-2, block 540).

In some scenarios, the base station may determine that UE is to operate in multi-Rx mode (block 530—NO). For example, the UE may previously have designated a preference, and/or the base station may have determined that the UE is to operate in multi-Rx mode. Such a preference and/or determination is described further with reference to FIG. 3, and may include a determination that the UE is attempting to add the base station as a PSCell, replace a previous PSCell with the base station, that the base station is to facilitate DC communication with the UE, and the like.

In some scenarios, the base station may determine that L3 measurement(s) satisfies one or more criteria (block 550). The one or more criteria may include a criterion that is satisfied when may include a criterion that is satisfied based upon UE mobility estimates (e.g., an inter-frequency or intra-frequency measurement), based upon UE location, based upon UE QoS, and/or a criterion that is satisfied when the UE is or is to be configured for FR2-only CA operation as described further herein. In some scenarios, the base station may determine that fast beam sweeping at the UE is preferred, beneficial, and/or required. Accordingly, the base station may transmit a request and/or configuration information for the UE to perform the beam sweeping according to a first configuration (Block 560—YES). In some scenarios, the first configuration may include a first beam sweeping factor that is less than the default beam sweeping factor, to reduce the amount of time required for the UE to search for and/or evaluate a new cell.

In some scenarios, the base station may determine that the one or more criteria are not satisfied, and therefore that the beam sweeping at the UE is not preferred, beneficial, and/or required (Block 560—NO). For example, the base station may determine that the UE is configured for FR1-FR2 CA and/or DC (e.g., such that a PCell supports the FR1 frequency range), and/or that the UE is configured for EN-DC (e.g., such that a Pcell supports the LTE frequency range). Accordingly, the base station may transmit a request and/or configuration information for the UE to perform the beam sweeping according to a second configuration, different from the first, which may be the default configuration. In some scenarios, as described with reference to FIG. 6, the first and/or the second configuration may be based upon a beam sweeping factor, a pattern, and/or a periodicity determined by the base station.

FIG. 6 is a diagram of examples for configuring default and fast beam sweeping according to one or more implementations described herein. For example, plot 640 may illustrate a first SMTC configuration (e.g., a default configuration corresponding to block 510 in FIG. 5) of a series of SSB bursts transmitted by a base station. Plot 640 may reflect a beam sweeping factor of four (e.g., “N=4”), and may illustrate four bursts that may be transmitted by the base station. periodicity 611 may be a first value, defining the amount of time during a window of time that elapses between the initial transmission of bursts 602, 604, 606, and 608 included in a SMTC pattern. It is understood that the SMTC periodicity and/or the timing of SSB bursts described herein may correspond to the periodicity and/or timing of Rx beam sweeps performed by a UE in communication with the base station (e.g., when evaluating L3 measurements).

Plot 660 may illustrate a second SMTC configuration of transmission by a base station (e.g., corresponding to block 560 in FIG. 5) that reduces the amount of time required by the UE to sweep for the series of SSB bursts transmitted by the base station. Plot 660 may reflect a beam sweeping factor of two (e.g., “N=2”), and may illustrates two SSB bursts including bursts 612 and 614 that may be transmitted by the base station. Periodicity 621 may be a second value that is the same as the first value of periodicity 611. In some scenarios, the amount of time required to transmit the four SSB bursts partially illustrated in plot 640 may be greater than an amount of time required to transmit the two SSB bursts partially illustrated in plot 660. Accordingly, the base station may be able to reduce the time consumed transmitting SSB bursts to the UE, thus reducing the amount of time consumed evaluating a prospective attachment with the UE.

Plot 670 may illustrate a third SMTC configuration of transmission by a base station (e.g., corresponding to block 570 in FIG. 5). For example, the base station may determine that a UE is to be configured in multi-Rx operation, and that the default beam sweeping factor is suitable. Accordingly, periodicity 631 may be the same value as periodicity 611, and plot 670 may include SSB bursts 622, 624, 626, and 628 which are similar to or the same as bursts 602, 604, 606, and 608. In some scenarios, the UE may measure bursts 622 and 624, and may forgo measurement of bursts 626 and 628 in accordance with an indicated SSB burst pattern. For example, the base station that transmits the bursts included in plot 670 may indicate a SSB burst pattern of 1100, indicating that a two successive bursts (e.g., “11”) may be reserved for Rx beam sweeping, and two subsequent, successive bursts (e.g., “00”) may be freed for data reception. In such scenarios, the UE may receive data during the time periods that otherwise would be spent receiving bursts 626 and 628 for data reception. Thus, the base station may indicate a SSB burst pattern to the UE, indicating periods of time during which the UE may perform Rx beam sweeping for cell evaluation, and indicating other periods of time during which the UE may receive data.

In some scenarios, when a base station determines that a faster beam sweeping configuration is not preferred, beneficial, and/or required, the base station may configure the beam sweeping configuration for multi-Rx operation, different from a fast beam sweeping configuration and/or different from a default beam sweeping configuration. Increasing the SMTC periodicity and/or successively transmitting SSB bursts may free the UE to receive other signals during periods of time in which SSB bursts are not being received. For example, the base station may increase the SMTC periodicity—the time interval between subsequent bursts of SSBs—based upon a reported capability of the UE. For example, the SMTC periodicity may be increased by a ratio between a default value (e.g., N=8, N=12) and a preferred or determined value reported by the UE to the base station, or a fast beam sweeping value determined by the base station. Additionally or alternatively, the pattern of SSB bursts may be modified. For example, the base station may transmit a plurality of SSB bursts during successive SMTC periods, in the alternative to transmitting the plurality of SSB bursts including an idle SMTC period between successive SSB bursts.

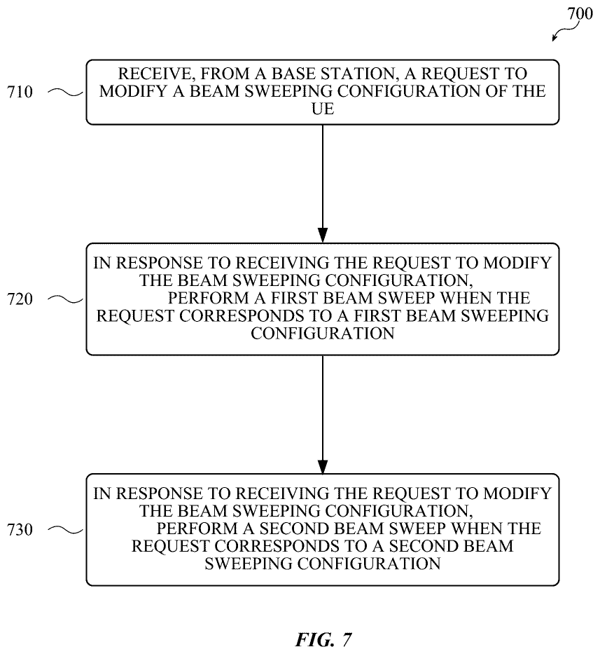

FIG. 7 is a diagram of a process 700 for configuring a Rx beam sweep of a UE according to one or more implementations described herein. In some scenarios, a user device (UE) may comprise memory, and one or more processors configured to, when executing instructions stored in the memory, cause the UE to receive (710) from a base station, a request to modify a beam sweeping configuration of the UE. In some scenarios, the one or more processors may be configured to, when executing instructions stored in the memory, cause the UE to, in response to receiving the request to modify the beam sweeping configuration perform (720) a first beam sweep when the request corresponds to a first beam sweeping configuration. In some scenarios, the one or more processors may be configured to, when executing instructions stored in the memory, cause the UE to, in response to receiving the request to modify the beam sweeping configuration perform (730) a second beam sweep, that is different from the first beam sweep, when the request corresponds to a second beam sweeping configuration, wherein the first beam sweep is faster than the second beam sweep.

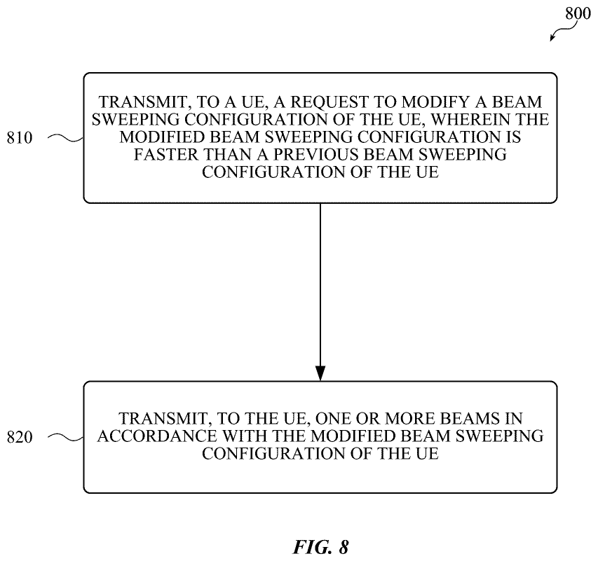

FIG. 8 is a diagram of a process 800 for configuring a Rx beam sweep of a UE according to one or more implementations described herein. In some scenarios, a base station (BS) may comprise, memory, and one or more processors configured to, when executing instructions stored in the memory, cause the BS to transmit (810), to a UE, a request to modify a beam sweeping configuration of the UE, wherein the modified beam sweeping configuration is faster than a previous beam sweeping configuration of the UE. In some scenarios, the one or more processors may be configured to, when executing instructions stored in the memory, cause the BS to transmit (820), to the UE, one or more beams in accordance with the modified beam sweeping configuration of the UE.

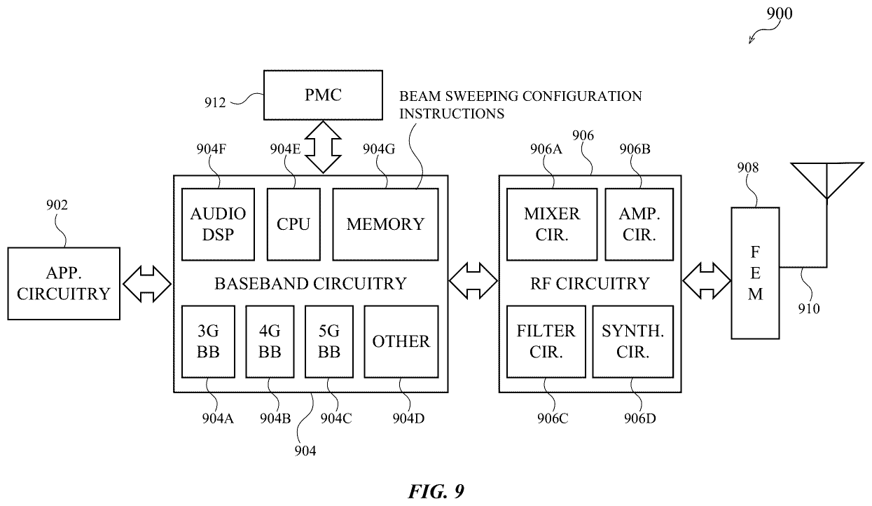

FIG. 9 is a diagram of an example of components of a device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuity 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.). The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 904G may receive and store one or more configurations, instructions, and/or other types of information to enable communication of beam sweeping configurations. The beam sweeping configurations may be used for L3 measurements and/or procedures. Further, the beam sweeping configurations may be a fast beam sweeping configuration to reduce interruption time incurred when evaluating a prospective attachment between a base station and user equipment. These and many other features and examples are described herein and may be enabled by the configurations, instructions, and/or other types of information stored by memory 904G.

In some implementations, the baseband circuitry 904 can include one or more audio digital signal processor(s) (DSP) 904F. The audio DSPs 904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path. In some implementations, the mixer circuitry 906A of the receive signal path can be configured to down-convert RF signals received from the FEM circuitry 908 based on the synthesized frequency provided by synthesizer circuitry 906D. The amplifier circuitry 906B can be configured to amplify the down-converted signals and the filter circuitry 906C can be a low-pass filter (LPF) or band-pass filter (BPF) configured to remove unwanted signals from the down-converted signals to generate output baseband signals. Output baseband signals can be provided to the baseband circuitry 904 for further processing. In some implementations, the output baseband signals can be zero-frequency baseband signals, although this is not a requirement. In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 908. The baseband signals can be provided by the baseband circuitry 904 and can be filtered by filter circuitry 906C.

In some implementations, the mixer circuitry 906A of the receive signal path and the mixer circuitry 906A of the transmit signal path can include two or more mixers and can be arranged for quadrature down conversion and up conversion, respectively. In some implementations, the mixer circuitry 906A of the receive signal path and the mixer circuitry 906A of the transmit signal path can include two or more mixers and can be arranged for image rejection (e.g., Hartley image rejection). In some implementations, the mixer circuitry 906A of the receive signal path and the mixer circuitry 1406A can be arranged for direct down conversion and direct up conversion, respectively. In some implementations, the mixer circuitry 906A of the receive signal path and the mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 906 can include analog-to-digital converter (ADC) and digital-to-analog converter (DAC) circuitry and the baseband circuitry 904 can include a digital baseband interface to communicate with the RF circuitry 906.

In some dual-mode implementations, a separate radio IC circuitry can be provided for processing signals for each spectrum, although the scope of the implementations is not limited in this respect.

In some implementations, the synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

The synthesizer circuitry 906D can be configured to synthesize an output frequency for use by the mixer circuitry 906A of the RF circuitry 906 based on a frequency input and a divider control input. In some implementations, the synthesizer circuitry 906D can be a fractional N/N+1 synthesizer.

In some implementations, frequency input can be provided by a voltage-controlled oscillator (VCO), although that is not a requirement. Divider control input can be provided by either the baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of the RF circuitry 906 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 906 can include an IQ/polar converter.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the FEM circuitry 908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 may be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as discontinuous reception mode (DRX) after a period of inactivity. During this state, the device 900 can power down for brief intervals of time and thus save power.

If there is no data traffic activity for an extended period, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 902 and processors of the baseband circuitry 904 can be used to execute elements of one or more instances of a protocol stack. For example, processors of the baseband circuitry 904, alone or in combination, can be used execute Layer 3, Layer 2, or Layer 1 functionality, while processors of the baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer I can comprise a physical (PHY) layer of a UE/RAN node, described in further detail below.

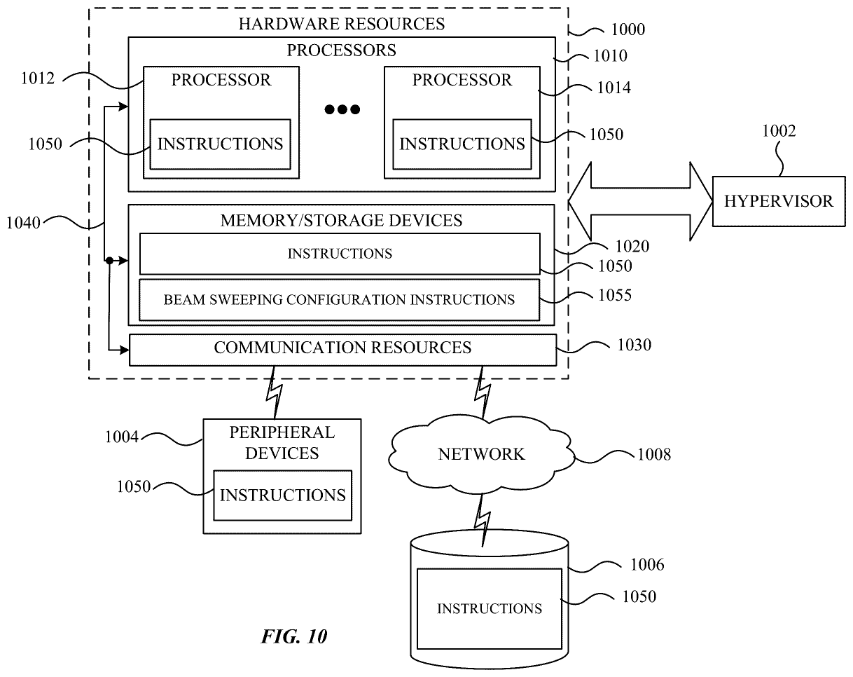

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For implementations where node virtualization (e.g., NFV) is utilized, a hypervisor may be executed to provide an execution environment for one or more network slices/sub-slices to utilize the hardware resources 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1014.

The memory/storage devices 1020 may include main memory, disk storage, or any suitable combination thereof. The memory/storage devices 1020 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1020 may receive and store one or more configurations, instructions, and/or other types of information 1055 to enable communication of beam sweeping configurations. The beam sweeping configurations may be used for L3 measurements and/or procedures. Further, the beam sweeping configurations may be a fast beam sweeping configuration to reduce interruption time incurred when evaluating a prospective attachment between a base station and user equipment. These and many other features and examples are described herein and may be enabled by the configurations, instructions, and/or other types of information stored by memory/storage devices 1020.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a universal serial bus (USB)), cellular communication components, NFC components, Bluetooth® components (e.g., Bluetooth® low energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise memory, and one or more processors configured to, when executing instructions stored in the memory, cause the UE to: receive, from a base station, a request to modify a beam sweeping configuration of the UE; and in response to receiving the request to modify the beam sweeping configuration: perform a first beam sweep when the request corresponds to a first beam sweeping configuration; and perform a second beam sweep, that is different from the first beam sweep, when the request corresponds to a second beam sweeping configuration.

In example 2, which may also include one or more of the examples described herein, the first beam sweep is completed in a first time interval, and the second beam sweep is completed in a second time interval that is greater than the first time interval.

In example 3, which may also include one or more of the examples described herein, the one or more processors are further configured to, when executing the instructions stored in the memory, cause the UE to transmit a beam sweeping capability to the base station, wherein the modified beam sweeping configuration of the UE is associated with the transmitted beam sweeping capability, wherein the first beam sweeping configuration corresponds to a multi-Rx beam sweeping configuration when the beam sweeping capability corresponds to fast beam sweeping, and the second beam sweeping configuration corresponds to a single-Rx beam sweeping configuration when the beam sweeping capability corresponds to default beam sweeping.

In example 4, which may also include one or more of the examples described herein, the request to modify the beam sweeping configuration is based upon one or more capability characteristics of the UE communicated to the base station. In example 5, which may also include one or more of the examples described herein, the one or more capability characteristics of the UE are communicated to the base station using one or more of UE assistance information (UAI), uplink control information (UCI), and medium access control (MAC) control elements (MAC CE). In example 6, which may also include one or more of the examples described herein, the one or more capability characteristics comprises one or more of an operating temperature of the UE and a designated number of multiple input multiple output (MIMO) layers associated with the UE.

In example 7, which may also include one or more of the examples described herein, the UE is in communication with a primary cell (PCell) and a primary secondary cell (PSCell) while the first beam sweep is performed, wherein the PCell and the PSCell operate within a frequency range from 24.25 gigahertz (GHz) to 71 GHz.

In example 8, which may also include one or more of the examples described herein, the UE is in communication with a PCell while the first beam sweep is performed, wherein the PCell operates at a frequency range up from 410 MHz to 7125 MHz.

In example 9, which may also include one or more of the examples described herein, the request corresponds to the first beam sweeping configuration when one or more of a UE mobility measurement, a location of the UE relative to a physical environment of the UE, and a quality of service (QoS) associated with the UE respectively satisfy one or more respective criteria.

In example 10, which may also include one or more of the examples described herein, the information including the request to modify the beam sweeping configuration of the UE includes a request to configure the UE for communication with a PCell and with a PSCell, includes a request to initiate communication with a PSCell, includes a request to replace communication with a first PSCell with communication with a second PSCell, or is included in a radio resource control (RRC) signal.

In example 11, which may also include one or more of the examples described herein, the request to update the beam sweeping configuration is associated with a first synchronization signal/physical broadcast channel block measurement timing configuration (SMTC) window corresponding to a first period of time. In example 12, which may also include one or more of the examples described herein, a periodicity of the first SMTC window is associated with a first beam sweeping factor. In example 13, which may also include one or more of the examples described herein, the second beam sweep is performed over a second period of time, different from the first period of time, based on a second SMTC window associated with a second beam sweeping factor. In example 14, the one or more processors are further configured to, when executing the instructions stored in the memory, cause the UE to perform one or more beam sweeps associated with a respective beam sweeping factor at respective one or more times. In example 15, which may also include one or more of the examples described herein, the respective one or more times correspond to a first periodicity of the first SMTC window when the request corresponds to the first beam sweeping configuration, and the respective one or more times correspond to a second periodicity of the first SMTC window, different from the first periodicity, when the request corresponds to the second beam sweeping configuration.

In example 16, which may also include one or more of the examples described herein, the one or more processors are further configured to, when executing the instructions stored in the memory, cause the UE to, receive, from the base station, a L3 procedure request including a handover request, PSCell addition request, or a PSCell change request, and after receiving the L3 request, and after updating the UE beam sweeping configuration, performing the L3 procedure using a beam based upon a result of the first beam sweep or based upon a result of the second beam sweep.

In example 17, which may also include one or more of the examples described herein, the first beam sweeping configuration includes an indication of a pattern of SSB bursts.

In example 18, which may also include one or more of the examples described herein, a base station comprising memory and one or more processors configured to, when executing instructions stored in the memory, cause the base station (BS) to transmit, to a UE, a request to modify a beam sweeping configuration of the UE, wherein the modified beam sweeping configuration is faster completed in a shorter time interval than completion of a previous beam sweeping configuration of the UE; and transmit, to the UE, one or more beams in accordance with the modified beam sweeping configuration of the UE. In example 19, which may also include one or more of the examples described herein, the request to modify the beam sweeping configuration of the UE corresponds to a first beam sweep performed at a first rate when the UE is configured for single-receive operation, and the request corresponds to a second beam sweep performed at a second rate, different from the first rate, when the UE is configured for multi-receive operation.

In example 20, which may also include one or more of the examples described herein, the request to modify the beam sweeping configuration is based upon one or more capability characteristics of the UE communicated to the base station. In example 21, which may also include one or more of the examples described herein, the one or more capability characteristics comprise one or more of an operating temperature of the UE and a designated number of multiple input multiple output (MIMO) layers associated with the UE. In example 22, which may also include one or more of the examples described herein, the one or more capability characteristics of the UE are communicated to the base station using one or more of UE assistance information (UAI), uplink control information (UCI), and medium access control (MAC) control elements (MAC CE).

In example 23, which may also include one or more of the examples described herein, the UE is in communication with a primary cell (PCell) and a primary secondary cell (PSCell) when the request to modify the beam sweeping configuration of the UE is transmitted, wherein the PCell and the PSCell operate within a frequency range from 24.25 GHz to 71 GHz.

In example 24, which may also include one or more of the examples described herein, the UE is in communication with a PCell when the request to modify the beam sweeping configuration of the UE is transmitted, wherein the PCell operates at a frequency range up from 410 MHz to 7125 MHz.

In example 25, which may also include one or more of the examples described herein, the request to modify the beam sweeping configuration of the UE is transmitted when one or more of a UE mobility measurement, a location of the UE relative to a physical environment of the UE, and a Quality of Service (QOS) associated with the UE respectively satisfy one or more respective criteria.

In example 26, which may also include one or more of the examples described herein, the request to modify the beam sweeping configuration of the UE includes a request to configure the UE for communication with a PCell and with a PSCell, includes a request to initiate communication with a PSCell, includes a request to replace communication with a first PSCell with communication with a second PSCell, or is included in a radio resource control (RRC) signal.

In example 27, which may also include one or more of the examples described herein, the request to update the beam sweeping configuration is associated with a first synchronization signal/physical broadcast channel block measurement timing configuration (SMTC) window corresponding to a first period of time. In example 28, which may also include one or more of the examples described herein, a periodicity of the first SMTC window is associated with a first beam sweeping factor. In example 29, which may also include one or more of the examples described herein, the previous beam sweeping configuration of the UE is associated with a second SMTC window corresponding to a second period of time, greater than the first period of time. In example 30, which may also include one or more of the examples described herein, wherein the one or more processors are further configured to, when executing the instructions stored in the memory, cause the BS to, one or more transmit beam sweeps associated with a respective beam sweeping factor based upon a default beam sweeping factor and an updated beam sweeping factor associated with the modified beam sweeping configuration. In example 31, which may also include one or more of the examples described herein, the respective one or more times correspond to a first periodicity of the first SMTC window when the modified beam sweeping configuration corresponds to a first beam sweeping configuration of the UE; and the respective one or more times correspond to a second periodicity of the first SMTC window, different from the first periodicity, when the modified beam sweeping configuration corresponds to a second beam sweeping configuration of the UE.

In example 32, which may also include one or more of the examples described herein, the modified beam sweeping configuration is associated with one or more layer 3 (L3) procedures. In example 33, which may also include one or more of the examples described herein, the modified beam sweeping configuration is further associated with one or more L3 measurements.

In example 34, which may also include one or more of the examples described herein, wherein the modified beam sweeping configuration includes a pattern of SSB bursts, including an indication of first one or more time periods corresponding to first one or more bursts that are reserved for Rx beam sweeping performed by the UE, and an indication of second one or more time periods, different from the first one or more time periods, that are reserved for data reception performed by the UE.

In example 35, which may also include one or more of the examples described herein, a basedband processor, is configured to when executing one or more instructions, cause a UE to perform according to one or more of the examples described herein. In example 36, which may also include one or more examples described herein, a method, performed by a UE, according to one or more examples described herein. In example 37, which may also include one or more examples described herein, a computer-readable medium, storing instructions is configured to cause one or more processors to perform according to one or more of the examples described herein. In example 38, which may also include one or more of the examples described herein, a basedband processor, is configured to when executing one or more instructions cause a base station to perform according to one or more of the examples described herein. In example 39, which may also include one or more of the examples described herein, a method, performed by a base station according to one or more of the examples described herein. In example 40, which may also include one or more of the examples described herein, a computer-readable medium, storing instructions configured to cause one or more processors to perform according to one or more of the examples described herein.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE) comprising:
memory; and
one or more processors configured to, when executing instructions stored in the memory, cause the UE to:
receive, from a base station, a request to modify a beam sweeping configuration of the UE; and
in response to receiving the request to modify the beam sweeping configuration:
perform a first beam sweep when the request corresponds to a first beam sweeping configuration; and
perform a second beam sweep, that is different from the first beam sweep, when the request corresponds to a second beam sweeping configuration.

2. The UE of claim 1, wherein the first beam sweep is completed in a first time interval, and the second beam sweep is completed in a second time interval that is greater than the first time interval.

3. The UE of claim 1, wherein the one or more processors are further configured to, when executing the instructions stored in the memory, cause the UE to:
transmit a beam sweeping capability to the base station, wherein the modified beam sweeping configuration of the UE is associated with the transmitted beam sweeping capability, wherein,
the first beam sweeping configuration corresponds to a multi-Rx beam sweeping configuration when the beam sweeping capability corresponds to fast beam sweeping, and
the second beam sweeping configuration corresponds to a single-Rx beam sweeping configuration when the beam sweeping capability corresponds to default beam sweeping.

4. The UE of claim 1, wherein the request to modify the beam sweeping configuration is based upon one or more capability characteristics of the UE communicated to the base station.

5. The UE of claim 4, wherein the one or more capability characteristics comprises one or more of an operating temperature of the UE and a designated number of multiple input multiple output (MIMO) layers associated with the UE.

6. The UE of claim 1, wherein the request corresponds to the first beam sweeping configuration when one or more of a UE mobility measurement, a location of the UE relative to a physical environment of the UE, and a quality of service (QoS) associated with the UE respectively satisfy one or more respective criteria.

7. The UE of claim 1, wherein the request to modify the beam sweeping configuration of the UE includes a request to configure the UE for communication with a PCell and with a PSCell, includes a request to initiate communication with a PSCell, includes a request to replace communication with a first PSCell with communication with a second PSCell, or is included in a radio resource control (RRC) signal.

8. The UE of claim 1, wherein the request to update the beam sweeping configuration is associated with a first synchronization signal/physical broadcast channel block measurement timing configuration (SMTC) window corresponding to a first period of time.

9. The UE of claim 1, wherein the one or more processors are further configured to, when executing the instructions stored in the memory, cause the UE to:
receive, from the base station, a L3 procedure request including a handover request, PSCell addition request, or a PSCell change request, and
after receiving the L3 request, and after updating the UE beam sweeping configuration, performing the L3 procedure using a beam based upon a result of the first beam sweep or based upon a result of the second beam sweep.

10. The UE of claim 1, wherein the first beam sweeping configuration includes an indication of a pattern of SSB bursts.

11. A base station (BS) comprising:
memory; and
one or more processors configured to, when executing instructions stored in the memory, cause the BS to:
transmit, to a UE, a request to modify a beam sweeping configuration of the UE, wherein the modified beam sweeping configuration is than a previous beam sweeping configuration of the UE; and
transmit, to the UE, one or more beams in accordance with the modified beam sweeping configuration of the UE.

12. The BS of claim 11, wherein:
the request to modify the beam sweeping configuration of the UE corresponds to a first beam sweep performed at a first rate when the UE is configured for single-receive operation, and
the request corresponds to a second beam sweep performed at a second rate, different from the first rate, when the UE is configured for multi-receive operation.

13. The BS of claim 11, wherein the request to modify the beam sweeping configuration is based upon one or more capability characteristics of the UE communicated to the base station.

14. The BS of claim 11, wherein the request to modify the beam sweeping configuration of the UE is transmitted when one or more of a UE mobility measurement, a location of the UE relative to a physical environment of the UE, and a Quality of Service (QOS) associated with the UE respectively satisfy one or more respective criteria.

15. The BS of claim 11, wherein the request to modify the beam sweeping configuration of the UE includes a request to configure the UE for communication with a PCell and with a PSCell, includes a request to initiate communication with a PSCell, includes a request to replace communication with a first PSCell with communication with a second PSCell, or is included in a radio resource control (RRC) signal.

16. The BS of claim 11, wherein the request to update the beam sweeping configuration is associated with a first synchronization signal/physical broadcast channel block measurement timing configuration (SMTC) window corresponding to a first period of time.

17. The BS of claim 16, wherein the one or more processors are further configured to, when executing the instructions stored in the memory, cause the BS to:
perform one or more transmit beam sweeps associated with a respective beam sweeping factor based upon a default beam sweeping factor and an updated beam sweeping factor associated with the modified beam sweeping configuration.

18. The BS of claim 11, wherein the modified beam sweeping configuration is associated with one or more layer 3 (L3) procedures.

19. The BS of claim 11, wherein the modified beam sweeping configuration includes a pattern of SSB bursts, including:
an indication of first one or more time periods corresponding to first one or more bursts that are reserved for Rx beam sweeping performed by the UE, and
an indication of second one or more time periods, different from the first one or more time periods, that are reserved for data reception performed by the UE.

20. A basedband processor, which when executing one or more instructions, cause a UE to:
receive, from a base station, a request to modify a beam sweeping configuration of the UE;
in response to receiving the request to modify the beam sweeping configuration:
perform a first beam sweep when the request corresponds to a first beam sweeping configuration; and
perform a second beam sweep, that is different from the first beam sweep, when the request corresponds to a second beam sweeping configuration.
